(19) United States
(12) Patent Application Publication
(10) Pub. No.: US 2026/0089511 A1
(43) Pub. Date: Mar. 26, 2026

(54) GENERATION OF ANALYTICS FOR USE IN CYBER-ATTACK DETECTION IN A WIRELESS COMMUNICATIONS NETWORK

(71) Applicant: Lenovo (Singapore) Pte. Ltd., Singapore (SG)

(72) Inventors: Andreas KUNZ, Ladenburg (DE); Dimitrios KARAMPATSIS, Ruislip (GB); Sheeba Backia Mary BASKARAN, Friedrichsdorf (DE)

(21) Appl. No.: 19/111,211

(22) PCT Filed: Nov. 14, 2022
(86) PCT No.: PCT/EP2022/081816

§ 371 Date: Mar. 12, 2025

(30) Foreign Application Priority Data
Sep. 29, 2022 (GR) 20220100799

(51) Int. Cl. H04W 12/122; H04W 24/10; H04W 64/00

(52) U.S. Cl. CPC H04W 12/122; H04W 24/10; H04W 64/00

(57) ABSTRACT

There is provided an apparatus comprising a transceiver, and a processor coupled to the transceiver. The processor and the transceiver are configured to cause the apparatus to: receive a cause value indicative of a type of cyber-attack; receive a list of one or more remote device identifiers, wherein each of the one or more remote device identifiers identifies a remote device; select one or more measurement parameters based on the cause value; send a measurement request to a network function on another apparatus, the measurement request comprising the list of one or more remote device identifiers and the one or more measurement parameters; receive, in response to the measurement request, from the network function, a measurement response comprising one or more measurement reports associated with the list of remote device identifiers and the one or more measurement parameters; and generate analytics based on the one or more measurement reports.

### FIELD

The subject matter disclosed herein relates generally to the field of cyber-attack detection, and more specifically to the generation of analytics for use in cyber-attack detection. This document defines an apparatus, e.g. a network function, for generating data analytics for the detection of cyber-attacks, and a corresponding method of generating data analytics.

### BACKGROUND

In 3GPP TR 33.738 V0.2.0 (2022-07), a study on security aspects of enablers for Network Automation for 5G—phase 3, Release 18, a Network Data Analytics Function, NWDAF, may detect cyber-attacks by monitoring events and data packets in user equipment, UE, and the network. This may be done with the support of machine-learning algorithms.

### SUMMARY

Disclosed herein are procedures for using measurement data, such as UE measurement data, in the NWDAF to generate data analytics in order to detect cyber-attacks.

There is provided an apparatus comprising a transceiver and a processor coupled to the transceiver. The processor and the transceiver configured to cause the apparatus to: receive a cause value indicative of a type of cyber-attack: receive a list of one or more remote device identifiers, wherein each of the one or more remote device identifiers identifies a remote device; select one or more measurement parameters based on the cause value: send a measurement request to a network function on another apparatus, the measurement request comprising the list of one or more remote device identifiers and the one or more measurement parameters: receive, in response to the measurement request, from the network function, a measurement response comprising one or more measurement reports associated with the list of remote device identifiers and the one or more measurement parameters; and generate analytics based on the one or more measurement reports.

There is further provided a method for performance by an apparatus in a wireless communication network. The method comprises: receiving a cause value indicative of a type of cyber-attack: receiving a list of one or more remote device identifiers, wherein each of the one or more remote device identifiers identifies a remote device: selecting one or more measurement parameters based on the cause value: sending a measurement request to a network function on another apparatus in the wireless communication network, the measurement request comprising the list of one or more remote device identifiers and the one or more measurement parameters: receiving, in response to the measurement request, from the network function, a measurement response comprising one or more measurement reports associated with the list of remote device identifiers and the one or more measurement parameters; and generating analytics based on the one or more measurement reports.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for the generation of analytics for use in cyber-attack detection will now be described, by way of example only, with reference to the accompanying drawings, in which:

FIG. 1 illustrates an embodiment of a wireless communication system:

FIG. 2 depicts a user equipment apparatus:

FIG. 3 depicts further details of the network node:

FIG. 4 is a process flow chart showing a method of generating analytics from measurements data for cyber-attack detection; and

FIG. 5 is a process flow chart showing certain steps of a method for performance by an apparatus in a wireless communication network.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

In TR 33.738, with regard to cyber-attack detection, the NWDAF may detect cyber-attacks by monitoring events and data packets in a UE and the network, with the support of machine-learning algorithms. This was based on a use case from 3GPP TR 23.700-91, V17.0.0 (2020-12), a study on enablers for network automation for the 5G System (5GS), Phase 2, Release 17. The use case was not followed up in the subsequent study in 3GPP TR 23.700-81 V1.0.0 (2022-09), Study of Enablers for Network Automation for 5G, 5G System (5GS), Phase 3, Release 18: nor was it followed up in the normative specification in 3GPP TS 23.288, V17.6.0 (2022-09), Architecture enhancements for 5G System (5GS) to support network data analytics services, Release 17.

The specific cyber-attacks for which an analytics function may provide detection support include, but are not limited to, the following examples:
(1) Man in the Middle, MitM, attacks on the radio interface. MitM attacks or fraudulent relay nodes may modify or change messages between the UE and the RAN, resulting in failures of higher layer protocols such as NAS or the primary authentication.
(2) Denial of Service (DoS) attacks including Distributed Denial of Service (DDoS) attacks.

5G has high performance requirements for system capacity and data rate. Improved capacity and higher data rate may lead to much higher processing capability cost for network entities. This may make some network entities (e.g., a Radio Access Network (RAN), and Core Network Entities) susceptible to DDoS attacks. The NFs may also enable the detection of DDoS attacks.

The following two security threats are identified in TR 33.738:
“Cyber-attack may not be detected by the 5G network: thus further attacks could be conducted.
Anomaly events may not be detected by the 5G network: thus further attacks could be conducted.”

Malicious user equipment (UE) behaviour detection based on analytics was already discussed in TS 23.228. This covers statistics from different network functions about the behaviour of UEs in order to identify a misbehaving UE with the help of the NWDAF statistics.

Further, the detection of MitM attacks were discussed in the 3GPP TR 33.809 V0.19.0 (2022-06), “Study on 5G security enhancements against False Base Stations (FBS)”, Release 18. However, discussed solutions proposed to protect the System Information Block broadcasting so that the UE can identify a base station which does not provide the correct protected data.

To date, there is no solution to the problem of detecting cyber-attacks which involves measurement data, e.g. from one or more UEs, for analytics in the NWDAF in order to detect cyber-attacks.

The present application presents a solution to this problem.

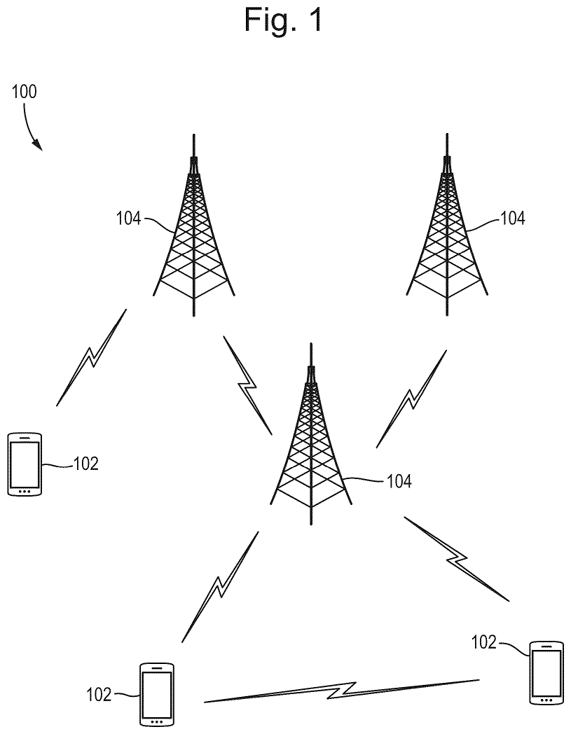

FIG. 1 depicts an embodiment of a wireless communication system 100 in which methods and apparatuses for cyber-attack detection may be implemented. The wireless communication system 100 may be used to implement herein-described methods and apparatuses for the generation of analytics for use in cyber-attack detection. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

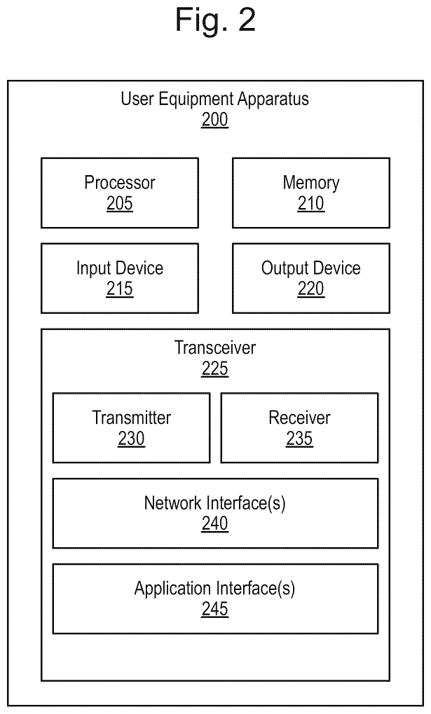

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may be in accordance with or the same as the remote unit 102 of FIG. 1. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a key board, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communications network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware 20) components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

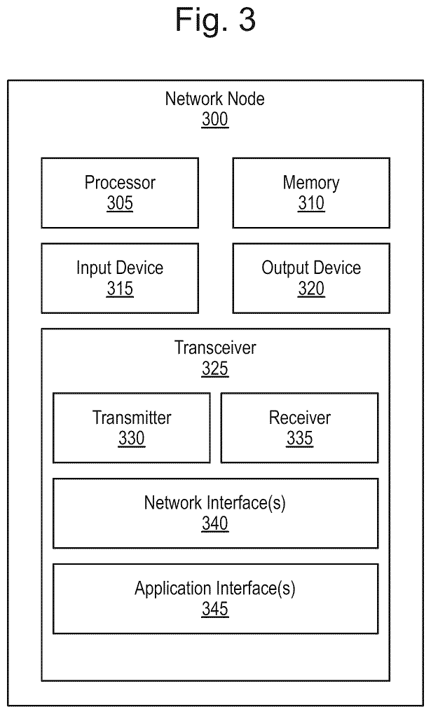

FIG. 3 depicts further details of the network node 300 that may be used for implementing the methods described herein. The network node 300 may be one implementation of an entity in the wireless communications network, e.g. in one or more of the wireless communications networks described herein, e.g. the wireless network 100 of FIG. 1. The network node 300 may be, for example, the UE apparatus 200 described above, or a Network Function (NF) or Application Function (AF), or another entity, of one or more of the wireless communications networks of embodiments described herein, e.g. the wireless network 100 of FIG. 1. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

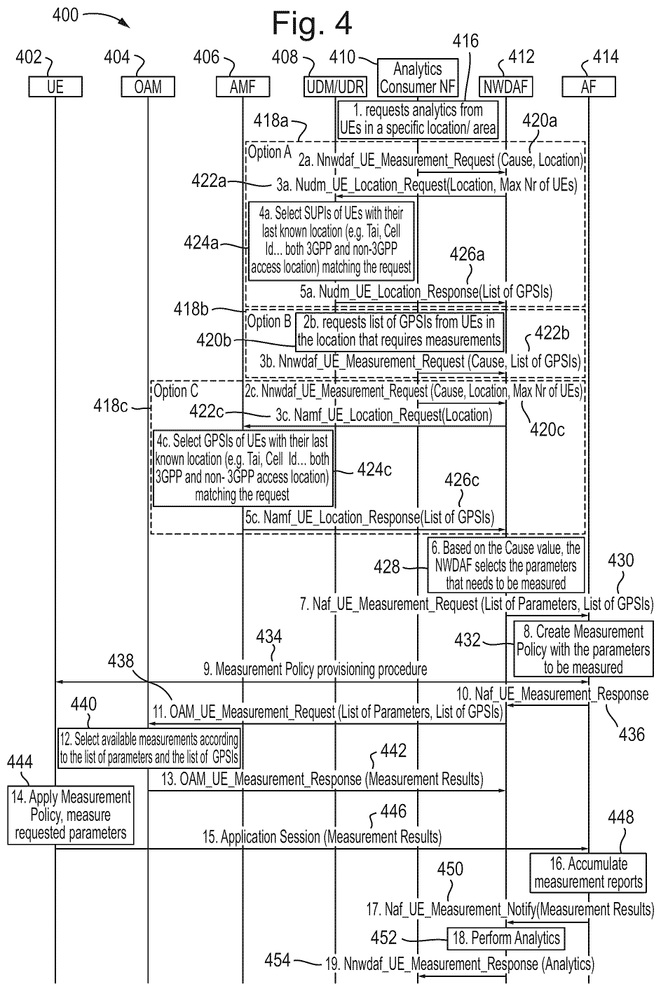

FIG. 4 is a process flow chart showing a method 400 of generating analytics for cyber-attack detection, such as the detection of MitM attacks.

The method 400 may involve a UE 402, an OAM system 404, an AMF 406, a UDM/UDR 408, an Analytics Consumer Network Function (NF) 410, an NWDAF 412, and an AF 416.

In this embodiment, the NWDAF 412 generates analytics based on the received measurements from UEs 402 and/or from the OAM system 404 in order to detect anomalies and cyber-attacks, such as MitM attacks.

The UE 402 may be the same as or in accordance with any of the UEs described herein, such as the UE 200 shown in FIG. 2 and described in more detail earlier above.

The OAM system 404, the AMF 406, the UDM/UDR 408, the Analytics Consumer NF 410, the NWDAF 412, and/or the AF 416 may be the same as or in accordance with any network entity, function, or node described herein. For example, OAM system 404, the AMF 406, the UDM/UDR 408, the Analytics Consumer NF 410, the NWDAF 412, and/or the AF 416 may be the same as the network node 300 shown in FIG. 3 and described in more detail earlier above.

In some embodiments, the Analytics Consumer NF 410 may be the same as the OAM system 404, or the NWDAF 412, or another network function.

At step 416, the Analytics Consumer NF 410 wants to retrieve analytics for a specific cause (e.g. a DoS attack, a MitM attack, etc.) in a specific location/area (e.g. a specific geographic location which may be identified by a Cell ID, TAI, list of cells or TAIs, etc.).

In order to retrieve the identities of the UEs 402 in the specific location/area, the NWDAF 412 may query the UDM/UDR 408, the OAM system 404, and/or the AMF 406. In this embodiment, the process steps of either Option A 418a, Option B 418b, or Option C 418c are performed. Options A-C 418a-c will now be described. After performing one or Options A-C 418a-c, the method continues with step 428 which will described later below after the description of Options A-C 418a-c.

Option A comprises steps 420a, 422a, 424a, and 426a.

At step 420a, the Analytics Consumer NF 410 sends a request, Nnwdaf_UE_Measurement_Request, to the NWDAF 412. This request comprises an indication of the cause (i.e., a cause value that may be indicative of a cyber-attack occurring or suspected and/or a type of cyber-attack) and location information that identifies the specific location/area (e.g., a specific geographic location which may be identified by a Cell ID, TAI, list of cells or TAIs, etc.).

At step 422a, the NWDAF 412 sends a request, Nudm_UE_Location_Request, to the UDM/UDR 408. This request includes the location information and, optionally, a maximum number of UE identities that the NWDAF 412 would like to have to perform the analytics later. The maximum number of UEs limits the numbers of UE identifiers (i.e., SUPIs/GPSIs in this embodiment) to a maximum number in the list to achieve a tradeoff between there being a reasonable number of measurements for meaningful analytics and on the other hand the overhead processing and signaling to receive the measurements.

At step 424a, the UDM/UDR 408 selects the SUPIs/GPSIs of the UEs 402, where the last know location information stored in the UDM/UDR 408 matches the location information of the request received from the NWDAF 412. The UDM/UDR 408 may limit the number of SUPIs/GPSIs to the maximum number given by the NWDAF 412.

At step 426a, the UDM/UDR 408 sends the list of SUPIs/GPSIs to the NWDAF 412 in a response message, Nudm_UE_Location_Response.

Thus, the process steps of Option A are provided. After step 426a, the method 400 proceeds to step 428, which is described later below.

Option B comprises steps 420b and 422b.

At step s420b, the Analytics Consumer NF 410 queries the UDM/UDR 408 with the location information in order to get the SUPIs/GPSIs of the UEs 402 residing in the last known stored location that matches the location information. The Analytics Consumer NF 410 or the UDM/UDR 408 may limit the numbers of SUPIs/GPSIs to a maximum number in the list to achieve a tradeoff of a reasonable number of measurements for meaningful analytics and on the other hand the overhead processing and signaling to receive the measurements.

At step 422b, the Analytics Consumer NF 410 sends a message, Nnwdaf_UE_Measurement_Request, with an indication of the cause (i.e. a cause value that may be indicative of a cyber-attack occurring and/or a type of cyber-attack) and the list of SUPIs/GPSIs to the NWDAF 412.

Thus, the process steps of Option B are provided. After step 422b, the method 400 proceeds to step 428, which is described later below.

Option C comprises steps 420c, 422c, 424c, and 426c.

At step 420c, the Analytics Consumer NF 410 sends a request, Nnwdaf_UE_Measurement_Request, to the NWDAF 412. This request comprises an indication of the cause (i.e. a cause value that may be indicative of a cyber-attack occurring or suspected and/or a type of cyber-attack) and location information that identifies the specific location/area (e.g. a specific geographic location which may be identified by a Cell ID, TAI, list of cells or TAIs, etc.).

At step 422c, the NWDAF 412 selects one or more AMFs 406 and sends a request, Namf_UE_Location_Request, to the AMF(s) 406. This request comprises the location information and a maximum number of UE identities the NWDAF 412 would like to have to perform the analytics later.

At step 424c, the AMF 406 selects the SUPIs/GPSIs of the UE(s) 402, where the last know location information stored in the AMF 406 matches the location information of the request from the NWDAF 412. The AMF 406 may limit the number of SUPIs/GPSIs to the maximum number given by the NWDAF 412. The maximum number of UEs 402 limits the numbers of SUPIs/GPSIs to a maximum number in the list to achieve a tradeoff between a reasonable number of measurements for meaningful analytics and on the other hand the overhead processing and signaling to receive the measurements.

At step 426c, the AMF 406 sends the list of SUPIs/GPSIs to the NWDAF 412 in a response message, Namf_UE_Location_Response.

Thus, the process steps of Option C are provided. After step 426c, the method 400 proceeds to step 428, which will now be described. Steps 428 to 454 are common to all Options A-C 418a-c.

At step 428, the NWDAF 412 selects the parameters (e.g. for a MitM attack, the NWDAF may select Unexpected GUTI failures, RRC message timeouts, NAS message timeouts, RRC message protection failure, NAS message protection failure, Authentication failure, Registration failure, etc.) to be measured based on the indication of the cause, i.e. the cause value. Those parameters may be different for different type of cause/cyber-attack. For example, different parameters may be measured depending on whether a MitM attack or a DoS attack is suspected. The NWDAF 412 may select a meaningful time duration for the measurements.

At step 430, the NWDAF 412 sends a request, Naf_UE_Measurement_Request, to the AF 414. This request includes the list of SUPIs/GPSIs, the parameters to be measured, and the measurement duration. The NWDAF 412 may provide the location information to the AF 414. The NWDAF 412 may subscribe to notifications on the measurement reports.

At step 432, the AF 414 creates a measurement policy based on the parameters to be measured.

At step 434, the AF 414 sends a Measurement Policy provisioning message to the UEs 402 identified by the SUPIs/GPSIs. The AF 414 may trigger a new application session in case the UE 402 is not connected to the AF 414 at this point in time.

At step 436, the AF 414 acknowledges the request from the NWDAF 412 in a Naf_UE_Measurement_Response message.

At step 438, the NWDAF 412 sends an OAM_UE_Measurement_Request to the OAM system 404. This request contains the list of parameters to be measured, the list of SUPIs/GPSIs, and the measurement duration. The NWDAF 412 may request other suitable NFs (e.g., the AMF 406, a AUSF, and/or the UDM 408, etc.) for protocol failure reporting for the list of UEs 402.

At step 440, the OAM system 404 initiates the measurements according to the parameters or selects the available measurements for the SUPIs/GPSIs.

At step 442, the OAM system 404 provides the measurements for the list of SUPIs/GPSIs (i.e., the measurement results) to the NWDAF 412 in a response message, OAM_UE_Measurement_Response.

At step 444, the UEs 402 apply the Measurement Policy from the AF 406 and perform the measurements accordingly for the measurement duration. In some embodiments, if the location information is included in the Measurement Policy, then the UEs 402 may only perform the measurement as long it is located in the area matching the location information.

At step 446, the UEs 402 provide the measurement results to the AF 414 after the measurement duration has expired. These measurement results may be provided to the AF 414 in measurement reports,

At step 448, the AF 414 accumulates the measurement reports from the UEs 402.

At step 450, the AF 414 sends the accumulated measurement reports to the NWDAF 412.

At step 452, the NWDAF 412 performs analytics based on the measurement results from the OAM system 404 and based on the accumulated measurement results/reports from the AF 414. The NWDAF 412 may detect anomalies in the received measurements results/reports. The NWDAF 412 may compares the results from the two sources (i.e., the OAM system 404 and the UEs/AF 402/414).

At step 454, the NWDAF 412 provides the analytics back to the Analytics Consumer NF 410 in a response message, Nnwdaf_UE_Measurement_Response.

Thus, the method 400 of generating analytics for cyber-attack detection, such as the detection of MitM attacks, is provided.

The following information specifies further details on the analytics that may be used for MitM detection in the NWDAF.

In embodiments described herein, the NWDAF can collect information from different NFs and UEs in order to provide the relevant information to the NF consumer, requesting the analytics (e.g., the Analytics Consumer NF 410). An MitM attack may lead to dropped or changed packets between the UE and the legitimate gNB: the failures and timeouts with respect to the NAS messages are relevant for the analytics. Once a UE is camping at a MitM base station, the MitM base station tends to drop packets or tends to not let the UE to perform the normal procedures in order to keep the UE camping as long as possible. This will tend to lead to service disruption at the UE at that point in time, which will be measured according to the measurement policy in the UE. Further information from the UDM and AUSF about the authentication status and the registration status in the network can give additional information. In case of a roaming scenario, the information from the AMF may not be considered available together with the information from the AUSF/UDM. The AMF may not recognize any signaling, or only partial messages when the UE is connected via MitM base station. The UE can only provide the measurement reports back to the AF when it is connected to a legitimate gNB.

The detailed information collected by the NWDAF includes signaling data related to UE registration procedure. This may be as defined in Table 1 below.

TABLE 1
Description of expected UE signalling failures
per Exception ID in Serving Network

| Exception ID | Description | Source NF |
|---|---|---|
| Unexpected GUTI | AMF receives a service request | AMF, UE |
| | with a GUTI allocated by a | |
| | different PLMN, no UE | |
| | context is available at the AMF. | |
| NAS message | NAS messages are not received by the | AMF, UE |
| timeouts | AMF and dropped by the MitM attacker | |
| NAS message | NAS Security Mode | AMF, UE |
| protection | Complete is protected | |
| failure | with the wrong NAS keys | |
| RRC message | RRC messages are protected with the | gNB, UE |
| protection | wrong AS keys | |
| failures | | |
| RRC | RRC message are not | gNB, UE |
| message | received by the gNB | |
| timeouts | or the UE and dropped by | |
| | the MitM basestation | |

The gNB protocol failure information may be available via the OAM system.

The NWDAF performs the analytics based on the OAM and UE measurement reports and may also take information from other NFs into account (such as the AMF, UDM, and/or AUSF). Based on the analytics, the NWDAF detects the anomalies of the UEs when they are camped at a MitM base station.

The exceptions information from the UEs, the OAM, the AMF and the UDM may be as specified in Table 1, above, and/or Table 2, below.

TABLE 2
Description of expected UE signalling failures
per Exception ID in the Home Network and UE

| Exception ID | Description | Source NF |
|---|---|---|
| Unexpected PLMN | The UE sends a re-registration message | UDM |
| | from a different PLMN within an | |
| | unexpected time interval since the last | |
| | registration. | |
| Registration failure | Primary authentication was successful, but | UDM, UE |
| | AMF reports a registration failure. | |
| Authentication failure | Dropped NAS messages for the | AUSF, UE |
| | authentication lead to timeout/repetition | |
| | failure of the authentication method | |

On request of the service consumer (e.g. the Analytics Consumer NF 410), the NWDAF collects and analyses UE signaling failure information and/or expected UE behavioural parameters from the 5GC NFs (e.g. the AMF, the UDM, and/or the AUSF), the OAM, and/or the UEs, depending on Exception IDs as shown in Table 3 below. Care should be taken with regards to load by avoiding to cause major extra signaling when collecting data for any UE.

The NWDAF stores the received exception information and measurements and organizes them based on the UE ID, as shown in Table 3 below.

TABLE 3
Exceptions information from UE, OAM, AMF, UDM and AUSF

| Information | Description |
|---|---|
| UE ID | 5G GUTI (AMF only), SUPI/GPSI to identify |
| | the UE |
| Exceptions (1 . . . max) | |
| (NOTE 1) | |
| >Exception ID | Indicating the Exception ID (such as |
| | Unexpected GUTI, RRC message timeouts, |
| | NAS message timeouts, RRC message |
| | protection failure, NAS message protection |
| | failure, Authentication failure, Registration |
| | failure etc. as defined in Table 1 and Table 2). |
| >Exception Level | Scalar value indicating the severity of the |
| | signalling failure behaviour. |
| >Exception trend | Measured trend (up/down/unknown/stable) |

NOTE 1:
The Exceptions information could help NWDAF to train a signalling failure classifier, which could be used to classify a UE behaviour data into Normal behaviour or Exception.

The following information specifies further details on the output analytics that may be generated (i.e. the analytics sent to the Analytics Consumer NF).

Corresponding to the signaling failure Analytics ID, the analytics result provided by the NWDAF may be defined in Table 1 and Table 2. Depending on the exception from different measurement reports from the UE, OAM and NFs, the NWDAF provides analytics of the exceptions and generates an estimation for a MitM attack as shown in Table 5. Signaling failure statistics information may be as defined in Table 4. Signaling failure predictions information is defined in Table 5.

TABLE 4
Signalling failure statistics

| Information | Description |
|---|---|
| Exceptions (1 . . . max) | List of observed exceptions |
| >Exception ID | The risk detected by NWDAF |
| >Exception Level | Scalar value indicating the severity of the signalling |
| | failure behaviour |
| >Exception trend | Measured trend (up/down/unknown/stable) |
| >UE characteristics | Internal Group Identifier, TAC |
| >SUPI list (1 . . . SUPImax) | SUPI(s) of the UE(s) affected with the Exception |
| >Ratio | Estimated percentage of UEs affected by the |
| | Exception within the Target of Analytics Reporting |
| >Amount | Estimated number of UEs affected by the Exception |
| | (applicable when the Target of Analytics Reporting = |
| | “any UE”) |

TABLE 5
MitM attack predictions

| Information | Description |
|---|---|
| Exceptions (1 . . . max) | List of predicted exceptions |
| >Exception ID | MitM attack |
| >Exception Level | Scalar value indicating the severity of the signalling |
| | failure behaviour |
| >Exception trend | Measured trend (up/down/unknown/stable) |
| >UE characteristics | Internal Group Identifier, TAC |
| >SUPI list (1 . . . SUPImax) | SUPI(s) of the UE(s) affected with the Exception |
| >Ratio | Estimated percentage of UEs affected by the |
| | Exception within the Target of Analytics Reporting |
| >Amount | Estimated number of UEs affected by the Exception |
| | (applicable when the Target of Analytics Reporting = |
| | “any UE”) |
| >Confidence | Confidence of this prediction |

In an embodiment, there is provided an apparatus comprising a transceiver, and a processor coupled to the transceiver. The processor and the transceiver are configured to cause the apparatus to: receive a cause value indicative of a type of cyber-attack; receive a list of one or more remote device identifiers, wherein each of the one or more remote device identifiers identifies a remote device; select one or more measurement parameters based on the cause value; send a measurement request (e.g., an OAM_UE_Measurement_Request) to a network function on another apparatus (e.g., an OAM, AF, AMF, AUSF, UDM, etc.), the measurement request comprising the list of one or more remote device identifiers and the one or more measurement parameters: receive, in response to the measurement request, from the network function, a measurement response (e.g., an OAM_UE_Measurement_Response) comprising one or more measurement reports associated with the list of remote device identifiers and the one or more measurement parameters; and generate analytics based on the one or more measurement reports.

The processor and the transceiver may be further configured to cause the apparatus to: receive location information (e.g., in a first request message, Nnwdaf_UE_Measurement_Request, which may also comprise cause value): send a second request message to a second network function on another apparatus, the second request message comprising the location information; and receiving, in response to the second request message, from the second network function, a message (e.g., a Nudm_UE_Location_Response) comprising the list of one or more remote device identifiers. Each of the identified remote devices may have a location that matches a location specified by the location information.

The processor and the transceiver may be further configured to cause the apparatus to send, to the second network function, an indication of a maximum number (and/or minimum number, or range, or a specific number) of remote devices. The number of remote device identifiers in the list of one or more remote device identifiers may be limited by the indicated number or range of numbers.

The second network function may be a network function selected from the group of network functions consisting of: a Unified Data Management, UDM, network function: a Unified Data Repository, UDR, network function; and an Access and Mobility management Function, AMF.

The processor and the transceiver may be further configured to cause the apparatus to generate a measurement duration time based on the cause value. The measurement request (e.g., an OAM_UE_Measurement_Request) may further comprise the measurement duration time.

The processor and the transceiver may be further configured to cause the apparatus to determine, based on the one or more measurement reports, a confidentiality value indicative of a likelihood of a cyber-attack having occurred. This may be communicated to an Analytics Consumer.

The network function to which the measurement request is sent may be selected from a group of network functions consisting of: an Operations, Administration and Maintenance, OAM, network function: an Application Function, AF: an Authentication Server Function, AUSF: a Unified Data Management, UDM, network function: a Unified Data Repository, UDR, network function; and an Access and Mobility management Function, AMF.

The processor and the transceiver may be further configured to cause the apparatus to send a first measurement request (e.g., an OAM_UE_Measurement_Request) to a first network function on another apparatus (e.g. an OAM). The first measurement request may comprise the list of one or more remote device identifiers and the one or more measurement parameters. The processor and the transceiver may be further configured to cause the apparatus to receive, in response to the first measurement request, from the first network function, a first measurement response (e.g., an OAM_UE_Measurement_Response) comprising one or more first measurement reports associated with the list of remote device identifiers and the one or more measurement parameters. The processor and the transceiver may be further configured to cause the apparatus to send a second measurement request (e.g., a Naf_UE_Measurement_Request) to a second network function on another apparatus (e.g., an AF). The second measurement request may comprise the list of one or more remote device identifiers and the one or more measurement parameters. The processor and the transceiver may be further configured to cause the apparatus to receive, in response to the second measurement request, from the second network function, a second measurement response (e.g., a Naf_UE_Measurement_Notify) comprising one or more second measurement reports associated with the list of remote device identifiers and the one or more measurement parameters. The analytics may be based on the one or more first measurement reports and the one or more second measurement reports. For example, the analytics may be based on a comparison between the one or more first measurement reports and the one or more second measurement reports. The first network function may be an OAM network function. The second network function may be an AF.

The processor and the transceiver may be further configured to cause the apparatus to send the generated analytics to an Analytics Consumer network function.

The apparatus may be an NWDAF.

The one or more remote device identifiers may comprise a Subscription Permanent Identifier, SUPI, and/or a Generic Public Subscription Identifier, GPSI.

The cause value may indicate a cause selected from the group consisting of: a Man-in-the-middle attack, MitM: a Distributed Denial-of-Service, DDoS, attack: a Denial-of-Service, DoS, attack; and a misbehaving network function attack.

The processor and the transceiver may be further configured to cause the apparatus to subscribe to notifications on the one or more measurement reports.

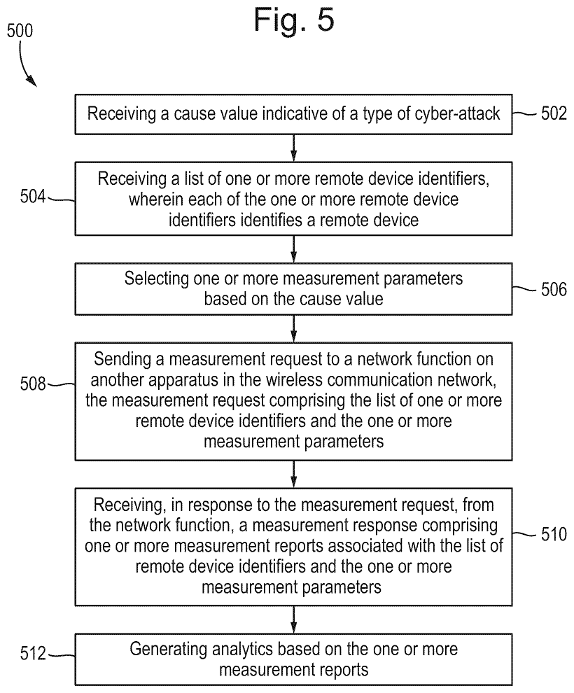

In an embodiment, there is provided a method for performance by an apparatus in a wireless communication network. FIG. 5 is a process flow chart showing certain steps of this method 500. The method comprises: receiving 502 a cause value indicative of a type of cyber-attack: receiving 504 a list of one or more remote device identifiers, wherein each of the one or more remote device identifiers identifies a remote device: selecting 506 one or more measurement parameters based on the cause value: sending 508 a measurement request to a network function on another apparatus in the wireless communication network, the measurement request comprising the list of one or more remote device identifiers and the one or more measurement parameters: receiving 510, in response to the measurement request, from the network function, a measurement response comprising one or more measurement reports associated with the list of remote device identifiers and the one or more measurement parameters; and generating 512 analytics based on the one or more measurement reports.

Conventionally, there is no solution where the analytics function (e.g., the NWDAF) provides detection support for cyber-attacks, such as MitM attacks, on the radio interface. MitM attacks or fraudulent relay nodes may modify or change messages between the UE and the RAN, resulting in failures of higher layer protocols such as NAS or the primary authentication.

In embodiments described herein, the NWDAF requests measurements from the OAM, UEs and/or other NFs for the UEs, for example, in the specific area where the Consumer Analytics NF suspects a cyber-attack. The NWDAF provides back analytics on the reported failures of the measurements and a prediction of a cyber-attack.

The solution provided by embodiments described herein include the reporting from the UE of different protocol levels (e.g., RRC, NAS), and the combining of measurement reports from different sources (e.g. UEs, OAM, NFs) for achieving a higher confidence of the estimation of an cyber-attack.

In some embodiments, the NWDAF requests measurements from the OAM, UEs and other NFs for the UEs in the specific area where the Consumer Analytics NF suspects an attack. The NWDAF provides back analytics on the reported failures of the measurements and a prediction of a cyber-attack, e.g. a MitM attack.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer
readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for wireless communication, comprising:
at least one memory; and
at least one processor coupled with the at least one memory and configured to cause the apparatus to:
receive a cause value indicative of a type of cyber-attack;
receive a list of one or more remote device identifiers, wherein each of the one or more remote device identifiers identifies a remote device;
select one or more measurement parameters based on the cause value;
send a measurement request to a network function on a second apparatus, the measurement request comprising the list of one or more remote device identifiers and the one or more measurement parameters;
receive, in response to the measurement request, from the network function, a measurement response comprising one or more measurement reports associated with the list of remote device identifiers and the one or more measurement parameters; and
generate analytics based on the one or more measurement reports.

2. The apparatus of claim 1, wherein the at least one processor is further configured to cause the apparatus to:
receive location information;
send a second request message to a second network function on a third apparatus, the second request message comprising the location information; and
receive, in response to the second request message, from the second network function, a message comprising the list of one or more remote device identifiers, wherein each of the identified remote devices has a location that matches a location specified by the location information.

3. The apparatus of claim 2, wherein the at least one processor is further configured to cause the apparatus to:
send, to the second network function, an indication of a maximum number of remote devices;
wherein the number of remote device identifiers in the list of one or more remote device identifiers is limited to the indicated maximum number.

4. The apparatus of 2, wherein the second network function is a network function, including:
a Unified Data Management (UDM) network function;
a Unified Data Repository (UDR) network function; or
an Access and Mobility management Function (AMF).

5. The apparatus of claim 1, wherein the at least one processor is further configured to cause the apparatus to:
generate a measurement duration time based on the cause value; wherein
the measurement request further comprises the measurement duration time.

6. The apparatus of claim 1, wherein the at least one processor is further configured to cause the apparatus to determine, based on the one or more measurement reports, a confidentiality value indicative of a likelihood of a cyber-attack having occurred.

7. The apparatus of claim 1, wherein the network function to which the measurement request is sent is:
an Operations, Administration and Maintenance (OAM) network function;
an Application Function (AF);
an Authentication Server Function (AUSF);
a Unified Data Management (UDM) network function;
a Unified Data Repository (UDR) network function; or
an Access and Mobility management Function (AMF).

8. The apparatus of claim 1, wherein the at least one processor is further configured to cause the apparatus to:
send a first measurement request to a first network function on a third apparatus, the first measurement request comprising the list of one or more remote device identifiers and the one or more measurement parameters;
receive, in response to the first measurement request, from the first network function, a first measurement response comprising one or more first measurement reports associated with the list of remote device identifiers and the one or more measurement parameters;
send a second measurement request to a second network function on a fourth apparatus, the second measurement request comprising the list of one or more remote device identifiers and the one or more measurement parameters; and
receive, in response to the second measurement request, from the second network function, a second measurement response comprising one or more second measurement reports associated with the list of remote device identifiers and the one or more measurement parameters; wherein
the analytics are based on the one or more first measurement reports and the one or more second measurement reports.

9. The apparatus of claim 8, wherein the analytics are based on a comparison between the one or more first measurement reports and the one or more second measurement reports.

10. The apparatus of claim 8, wherein:
the first network function is an Operations, Administration and Maintenance (OAM), network function; or
the second network function is an Application Function (AF).

11. The apparatus of claim 1, wherein the at least one processor is further configured to cause the apparatus to send the generated analytics to an Analytics Consumer network function.

12. The apparatus of claim 1, wherein the apparatus is a Network Data Analytics Function (NWDAF).

13. The apparatus of claim 1, wherein the one or more remote device identifiers comprise a Subscription Permanent Identifier (SUPI) or a Generic Public Subscription Identifier (GPSI).

14. The apparatus of claim 1, wherein the cause value indicates a cause, including:
a Man-in-the-middle attack, MitM;
a Distributed Denial-of-Service, DDoS, attack;
a Denial-of-Service, DoS, attack; or
a misbehaving network function attack.

15. The apparatus of claim 1, wherein the at least one processor is further configured to cause the apparatus to subscribe to notifications on the one or more measurement reports.

16. A method performed by an apparatus in a wireless communication network, the method comprising:
receiving a cause value indicative of a type of cyber-attack;
receiving a list of one or more remote device identifiers, wherein each of the one or more remote device identifiers identifies a remote device;
selecting one or more measurement parameters based on the cause value;
sending a measurement request to a network function on a second apparatus in the wireless communication network, the measurement request comprising the list of one or more remote device identifiers and the one or more measurement parameters;
receiving, in response to the measurement request, from the network function, a measurement response comprising one or more measurement reports associated with the list of remote device identifiers and the one or more measurement parameters; and
generating analytics based on the one or more measurement reports.

17. The method of claim 16, further comprising:
receiving location information;
sending a second request message to a second network function on a third apparatus, the second request message comprising the location information; and
receiving, in response to the second request message, from the second network function, a message comprising the list of one or more remote device identifiers, wherein each of the identified remote devices has a location that matches a location specified by the location information.

18. The method of claim 16, further comprising:
generating a measurement duration time based on the cause value,
wherein the measurement request further comprises the measurement duration time.

19. The method of claim 16, further comprising:
determining, based on the one or more measurement reports, a confidentiality value indicative of a likelihood of a cyber-attack having occurred.

20. A network function for wireless communication, comprising:
at least one memory; and
at least one processor coupled with the at least one memory and configured to cause the network function to:
receive a cause value indicative of a type of cyber-attack;
receive a list of one or more remote device identifiers, wherein each of the one or more remote device identifiers identifies a remote device;
select one or more measurement parameters based on the cause value;
send a measurement request to a network function on a second apparatus, the measurement request comprising the list of one or more remote device identifiers and the one or more measurement parameters;
receive, in response to the measurement request, from the network function, a measurement response comprising one or more measurement reports associated with the list of remote device identifiers and the one or more measurement parameters; and
generate analytics based on the one or more measurement reports.
